(19) United States
(12) Patent Application Publication
(10) Pub. No.: US 2019/0378162 A1
(43) Pub. Date: Dec. 12, 2019

(54) SYSTEMS AND METHODS FOR ENFORCING ADVERTISING STANDARDS AND DIGITAL ADVERTISEMENT MEASUREMENTS

(71) Applicant: KR8OS, Inc dba Lucidity, Marina Del Rey, CA (US)

(72) Inventors: Samuel Goldberg, Santa Monica, CA (US); Samuel Kim, Los Angeles, CA (US); Miguel Morales, Los Angeles, CA (US)

(73) Assignee: KR8OS, Inc dba Lucidity, Marina Del Rey, CA (US)

(21) Appl. No.: 16/434,159

(22) Filed: Jun. 6, 2019

Related U.S. Application Data
(60) Provisional application No. 62/681,439, filed on Jun. 6, 2018.

(51) Int. Cl. G06Q 30/02

(52) U.S. Cl. CPC G06Q 30/0242; G06Q 30/0201

(57) ABSTRACT

Systems and methods for enforcing advertising standards and digital advertisement measurements, including programmatic advertising analytics, to collect and verify advertising event data.

### CROSS-REFERENCE TO RELATED APPLICATIONS

This application claims priority to U.S. Provisional Application No. 62/681,439, filed on Jun. 6, 2018, the contents of which are incorporated herein by reference. This application is related to U.S. application Ser. No. 16/271,534, filed on Feb. 8, 2019, entitled “Scalable Decentralized Digital And Programmatic Advertising Analytics System.”

### TECHNICAL FIELD

The present disclosure generally relates to digital advertising analytics.

### BACKGROUND OF THE INVENTION

Digital advertising is almost a $300 billion industry globally. However, due to a broken and inconsistent supply chain, over $50 billion annually is lost for advertisers and publishers due to fraud. Digital advertising commonly appears on mobile, internet, internet browser, over-the-top (OTT), television, digital billboard, out-of-home digital, and videogame platforms, as well as other digital communication systems.

The supply chain in programmatic advertising operates in an opaque and fragmented manner among the 4-10 vendors typically required to handle the transfer of an advertisement from an advertiser for presentation to a consumer. Programmatic advertising is typically powered by an auction that occurs in real time each time a web page or mobile app is opened. These auctions are facilitated by specialized platforms enabling automated transactions. Without communication of data between each platform, data discrepancies are more than just expected, they may exceed 20%. As a result, malicious actors may infiltrate the programmatic advertising supply chain to engage in fraudulent activity, which can include illicit auction mechanics, identity theft, measurement inflation, and the like. Due to the lack of coordination and transparency, the fraud may be entirely undetected and involve parties unknown to the advertisers.

In a typical implementation of programmatic advertising, an ad request from a seller receives a bid response from a buyer, and the advertisement is supplied which eventually results in one impression, e.g., the advertisement is viewed once by a visitor, or displayed once on a web page. A fraudster may try to “steal” impressions by making an ad request that looks just like a non-fraudulent ad request. In that scenario, an unsuspecting buyer may respond to the fraudulent ad request and trigger supply of the advertisement but the fraudster does not display the advertisement to the agreed-upon viewer or web page. Nevertheless, the fraudster confirms that an impression did occur, requests payment, and is paid by the seller unable to detect the fraud.

Many other types of fraud occur in connection with digital advertising systems, such as programmatic systems, as well. The advertising auction process between buyer and seller can be corrupted by bid caching and bid shading. Impressions can be fabricated utilizing click injection techniques and bot farms. Valuable domains can be spoofed. In the U.S., law enforcement has been pursuing fraudsters and private lawsuits have sought compensation for the resulting losses.

Rigorous and fair evaluations of advertising performance are urgently needed in the advertising industry to combat large scale errors and fraud. The advertising industry does not have a mechanism to allow data sharing among advertising supply-chain participants in an efficient, verifiable, immutable way.

Advertising industry supply-chain participants typically include advertisers, advertising agencies, demand-side platforms (DSPs), supply-side platforms (SSPs), exchanges, ad servers, publishers, data management platforms (DMPs), viewability solutions, anti-fraud solutions, and third-party verification systems. DSPs provide technology enabling advertisers to operate the bidding process. SSPs provide technology enabling publishers to monetize their properties by opening bids when a page is loading. Exchanges facilitate the auction between the DSPs and SSPs. Ad servers host and distribute advertisement content to websites, social media platforms, and mobile applications. Some ad servers are also referred to as “campaign management platforms” (CMPs) and may be used to facilitate buying inventory, setting up advertising campaigns, monitoring results, and calculating performance metrics.

Publishers own properties that contain ad space (inventory) where an advertiser could display an advertisement. Data management platforms (DMPs) aggregate data and generate audience segments for advertisers to use for more specific consumer targeting. Third party verification systems provide additional layers of analysis to enable advertisers to better understand the delivery of their advertisements and detect, for example, fraud, brand safety, and viewability.

Currently, digital advertising is ripe with data inconsistencies which causes disputes among participants on what the final numbers are and complicates the billing process.

Existing advertising analytics solutions rely on centralized platforms, e.g., data centers controlled by a single party. Due to the centralization, typically no transparency is provided to advertising industry participants regarding the source or composition of the advertising data, leaving them to rely on the integrity of the controlling party. This single point of failure presents risk to the participants. The industry is in need of a solution that allows for participants in advertising campaigns to maintain privacy but also have access to reliable metrics regarding the advertising events in which they participate.

FIG. 1 is a diagram illustrating differing databases among participants in a prior art digital and programmatic advertising system. In a typical advertising campaign, advertisers 110, DSPs 120, SSPs 130, publishers 140, and others (not shown) keep separate records of their transactions involved in the campaign. An advertiser's database 112 stores information about the campaign that differs from the information stored in the DSP's database 122, the SSP's database 132, and the publisher's database 142. Certain aspects of the data stored in each database should match but conventional systems do not attempt to reconcile them. Where the data clearly does not match, it can be difficult, if not impossible, to determine whether the mismatch is due to processing errors, storage errors, asynchronous activity, hijacked resources, or other types of fraud.

Unable to measure the actual number of impressions served, determine the audience to which impressions were served, determine the audience which actually demonstrated interest in the advertisement, and the like, the advertiser has limited ability to effectively monitor the impact of a digital advertising campaign. Co-pending U.S. application Ser. No. 16/271,534, filed on Feb. 8, 2019, describes a scalable decentralized digital and programmatic advertising analytics system. That system would benefit from improved user interfaces, record-keeping structures, and communications systems.

Digital advertising has a fraud and measurement problem. Facebook has come under fire multiple times for inflating their video metrics. Juniper Research identified that digital advertising has over $19B annual fraud globally. Operating in individual data silos, supply chain participants that facilitate ad delivery lack the transparency and communication to keep the industry clean of fraudulent activity. As a result, the industry accepts a 10-20% discrepancy on campaign reports. Thus, there is a need for clear ad delivery and measurement standards that can be computed and enforced in a transparent way, and presented in a user-friendly way to enable advertisers to take action.

At present, the digital advertising industry has several sets of standards. Examples include MRC viewability standards, IAB standards, agency- and brand-specific standards (such as GroupM and P&G), or standards laid out by the Coalition for Better Ads. In each instance, however, there is no means of technologically enforcing these standards—instead, business incentives are utilized to maintain compliance. For example, a brand may require publishers to adhere to certain standards and will stop purchasing advertising inventory on those publishers if they are found to be non-compliant. This is a retroactive, or after the fact, effort to enforce said standards. As a result of an inability to track and enforce standards in real time, the ad industry faces many problems surrounding fraud and waste.

Predictive probabilistic solutions put in place before the start of an advertising campaign have obvious limitations—they are non-deterministic, merely beforehand estimates, and provide no real-time information during the course of the campaign.

Conventional “verification” systems, like those provided by MOAT, IAS and Double Verify, may provide viewability and brand safety measurement statistics but lack event level auditability of data that has received digital receipts from supply chain vendors and do not provide a way to technologically enforce advertising standards accurately.

### SUMMARY

An object of certain embodiments of the present invention is to provide a sophisticated user interfaces for real-time control over a digital programmatic advertising campaign.

Another object of certain embodiments of the present invention is to provide a secure record keeping structure that can be independently audited by the advertiser.

A further object of certain embodiments of the present invention is to provide a communication system enabling the advertiser to manage the exchange of confidential information among advertising campaign participants.

In accordance with an embodiment of the invention, a decentralized analytics system includes: a plurality of data sources; a decentralized verification system; a routing system, connected to the plurality of data sources and the decentralized verification system, for routing transaction data from the plurality of data sources to the decentralized verification system; wherein the decentralized verification system compares the transaction data to identify matched transaction data and unmatched transaction data; a private storage, connected to the decentralized verification system, to store the matched transaction data; and a public storage, connected to the decentralized verification system, to store a hash of the matched transaction data.

In accordance with another embodiment of the invention, a decentralized analytics processing method comprises the steps of: routing transaction data from a plurality of data sources to a decentralized verification system; comparing transaction data with a decentralized plurality of processing resources to identify at least one of matched transaction data and unmatched transaction data; time-series aggregating matched transaction data to produce aggregate data; storing aggregate data in a private storage; and storing a hash of the aggregate data in a public storage.

In accordance with a further embodiment of the invention, an analytics processing method comprises the steps of: routing transaction data from a plurality of data sources to a verification system; comparing transaction data to identify at least one of matched transaction data and unmatched transaction data utilizing a zero-knowledge proof; storing at least one of the matched transaction data in a private storage; and storing a hash of at least one of the matched transaction data in a public storage.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 is a diagram illustrating differing databases among participants in a prior art programmatic advertising system.

FIG. 2 is a diagram of a scalable, decentralized analytics system according to an exemplary embodiment of the present invention.

FIG. 3 is a diagram of a data structure according to an exemplary embodiment of the present invention.

FIG. 4 is a diagram of a distributed database system according to another exemplary embodiment of the present invention.

FIGS. 5A-5B are a graphical user interface according to an embodiment of the present invention.

FIGS. 6A-6C are a graphical user interface according to an embodiment of the present invention.

FIG. 7 is a graphical user interface according to an embodiment of the present invention.

FIG. 8 is a diagram of a system according to an exemplary embodiment of a smart contract of the present invention.

FIG. 9 is a diagram of a system according to an exemplary embodiment of the present invention depicting node verification.

FIG. 10 is a diagram of a system according to an exemplary embodiment of the present invention depicting node balance management.

FIG. 11 is a diagram of a system according to an exemplary embodiment of the present invention depicting withdrawal verification.

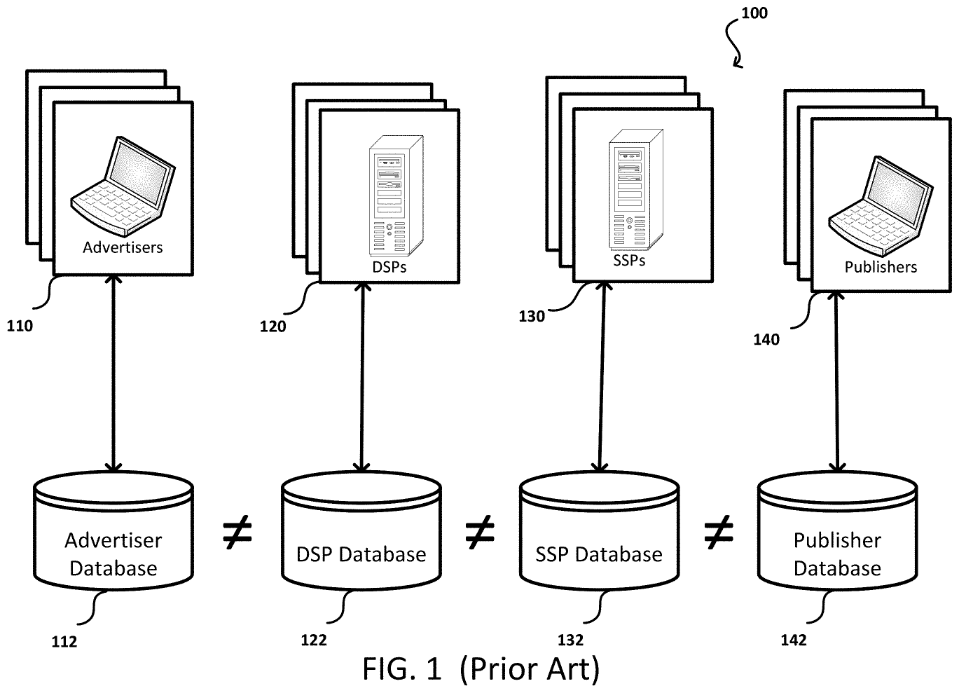

### DETAILED DESCRIPTION

The present disclosure is directed to systems and methods for computing advertising campaign metrics, storing campaign data securely, providing selective access to stored campaign, verifying stored campaign data, and enforcing digital advertisement delivery and measurement standards. The system enables a user to monitor and enforce compliance with advertising standards to ensure all participants in an advertisement delivery system are compliant with those standards.

Embodiments of the present invention provide systems and methods to enforce advertising campaign standards, monitor and improve advertising supply chain efficacy, and conduct event level evaluation in advertising. Advertising campaign data is stored securely to allow for auditing to confirm that publishers and vendors are in compliance with required standards.

Embodiments of the present invention enable a user to audit an advertising campaign and validate that all of the campaign data is authentic. A user-friendly blockchain auditing tool enables users to confirm that advertising campaign data has not been manipulated or otherwise changed. Using that immutable advertising campaign data, advertising campaign participants can reliably confirm that campaign metrics were properly calculated, the level of compliance with advertising standards, and whether advertising campaign payments should be and were made. Fair and consistent verification of campaign data can be achieved.

Embodiments of the inventions described in this disclosure are advantageously implemented in a diverse variety of industries and applications including, but not limited to, programmatic advertising, food supply chains, pharmaceutical manufacturing, intermodal shipping, videogame analytics, and the like. In certain embodiments, item tracking data provided by different transaction participants can be compared and correlated to determine the true status of the tracked items. Erroneous and fraudulent data can be detected, rejected, and traced to the culpable or compromised transaction participant.

Embodiments of the present invention provide systems and methods that reconcile data from multiple participants in a programmatic advertising supply chain. By comparing and contrasting data from multiple participants, the participants, especially advertisers and publishers, can obtain much more accurate information regarding the extent and efficacy of their respective efforts. Advertising expenditures can be traced to better determine return on investment and, preferably, more reliable data regarding the actual display of advertisements to viewers.

Embodiments of the present invention may include a clustering and routing mechanism, in which nodes are grouped as clusters and data is sharded by mapping data to different clusters, wherein those clusters come to a consensus within themselves and a final set of analytics is generated by aggregating the results of multiple clusters. The system combines a scalable way of routing transaction data and reaching consensus to verify transaction data, the corresponding transaction and/or related data.

With consistent and open sharing of programmatic advertising data, standards for defining advertising events can be programmatically codified and enforced to ensure that every participant in the supply chain is following the applicable rules, whether set by the advertising industry, an individual advertiser, or a group of such participants.

For each digital advertising campaign, e.g., a programmatic campaign, there are preferably at least three participants in the supply chain: a buyer (e.g., advertiser, agency, or DSP), a seller (e.g., SSP or publisher), and a third-party ad server (e.g., technology for serving and auditing the service of advertisements to a website, web browser, mobile application, or the like). In some circumstances, however, there could be only one or two supply chain participants. Data received from the supply chain participants are compared and correlated in order to reach a consensus on valid advertising event data. If data received from the participants match, a consensus on validity is automatically reached. When data from the participants does not match, a consensus mechanism is implemented to declare the validity or invalidity of the corresponding event and, unmatched data can be flagged, investigated, and categorized. Preferably, the identity of the participant that likely provided the non-matching data may be determined and recorded. In a preferred embodiment, the consensus mechanism is implemented as a smart contract on a blockchain to provide an impartial decision and an immutable audit trail. By sharing and matching data among supply chain participants, errors and fraud can be detected and reduced, if not eliminated entirely.

Preferably, granular advertising campaign-level signals are collected from tracking pixel, log-level or aggregate-level data. From such signals, multiple components of the data can be analyzed to identify matching data in order to reach a deterministic consensus. The criteria of interest for matching may vary depending on the identity of the participants and the types of transactions.

Advantageously, embodiments of the present invention may facilitate the identification of highly discrepant supply chain participants and of top performing placements according to supply chain congruence. Risky, fraudulent, honest, and/or compliant participants may be identified and tracked. Publishers are able to prevent loss of inventory and eliminate waste while obtaining transparency in their demand sources.

For illustrative purposes, the present invention will be described in the context of a programmatic advertising supply chain. As one of ordinary skill in the art will appreciate, implementation of the invention is not limited to that illustrative example.

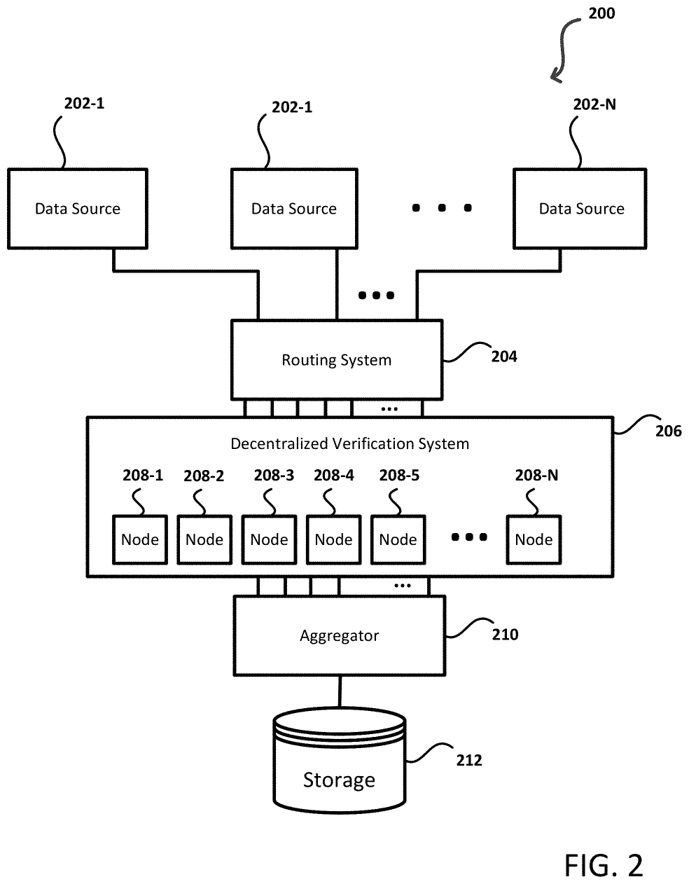

In FIG. 2, a scalable, decentralized analytics system 200 according to an exemplary embodiment of the present invention is shown. System 200 includes multiple data sources 202-1, 202-2 through 202-N; routing system 204; decentralized verification system 206, aggregator 210, and storage 212. Preferably, decentralized verification system 206 includes multiple processing nodes 208-1, 208-2, 208-3, 208-4, and 208-5 through 208-N. Optionally, routing system 204, aggregator 210, and/or storage 212 may be omitted.

Data sources 202-1, 202-2 through 202-N comprise conventional transaction data sources such as transacting parties, brokers, exchanges, third-party inspection services, payment processors, taxing authorities, and like transaction participants and observers. The data provided by each data source 202 may include transaction identification, participant identification, item identification, geographic location information, timing information, pricing information, payment information, other transaction details, and the like. The data provided by a data source 202 may be encrypted or digitally signed to establish the identity of the data source. Preferably, each item of data has a unique identifier (ID) that may be used for matching and checking against internal or external records. Optionally, the unique ID may be assigned by a participant, a data source 202, and/or routing system 204 and stored in internal or external storage.

Preferably, only authorized parties may qualify as a data source 202 or otherwise submit data via a data source 202. Authorization of a party to participate in system 200 may be provided with a separate security protocol such as a digital signature, cryptographic signature, or the like. Alternatively, a central registry of authorized participants may exist for the purpose of authorization and verification. Periodic or event-based verification of the identity of a party may be secured by the same or similar means, preferably via a data source 202 or routing system 204.

Routing system 204 is a computer system or software platform for routing data to decentralized verification system 204. Preferably, system 204 implements a consistent hashing algorithm to enable efficient scaling as the number of data sources 202, the amount of data, and the number of processing resources in system 206 changes. System 204 may include one or more load balancers, relayers, and exchanges. Preferably, a relayer is open source software run on a computing resource controlled by the data source 202 or routing system 204 that processes and packages the data for further transmission. Preferably, the participant may encrypt or digitally sign the data to create an auditable marking associated with the data and/or the data source. Optionally, the relayer may encrypt or digitally sign the data to create an auditable marking associated with the data and/or the data source. Alternatively, other conventional data routing methodologies may be implemented, such as round-robin, or the like. Optionally, routing system 204 is integrated into one or more of data sources 202-1 through 202-N or decentralized verification system 206.

Decentralized verification system 206 preferably comprises one or more computer processing resources for matching data. In a preferred embodiment, system 206 includes multiple nodes 208-1 through 208-N, each comprising a computer processing resource running open source software. A node 208 may be a computer server, a group of computer servers, a virtual server, a processing thread, or the like. The verification nodes 208-1 through 208-N may be grouped into clusters such that each cluster preferably will contain at least 5 (five) nodes. Optionally, data may enter through any node 208 in system 206. Communications among nodes 208-1 through 208-N and between nodes 208 and routing system 204, aggregator 210, and/or storage 212 may be provided by standard communications protocols such as internet protocols, e.g., hypertext transfer protocol (http).

In a preferred embodiment, nodes 208-1 through 208-N periodically reach a consensus on the matching of input data using a byzantine fault tolerant smart contract on a blockchain. Optionally, nodes 208 may verify data by checking identification data in internal or external storage, or the like, e.g., a public blockchain and may store duplicate data across multiple nodes for high availability and fault tolerance.

In another preferred embodiment, nodes 208-1 through 208-N are controlled by a consortium of advertising industry bodies or other neutral parties to provide decentralized operation of the nodes. In an alternate embodiment, nodes 208-1 through 208-N are controlled by single entity or a centralized entity. In a still further embodiment, a node 208 implements a zero-knowledge proof algorithm to confirm the validity of a data match.

In a preferred operation of an embodiment of the invention, data sources 202-1 through 202-N provide transactional data related to a single or series of interrelated transactions to routing system 204. Routing system 204 implements a routing algorithm to route the transaction data to individual or groups of processing resources within decentralized verification system 206. System 206 attempts to identify matches among the transactional data provided and reach a consensus regarding the validity of such matches. The matching data and/or consensus data is provided by system 206 to aggregator 210 or to storage 212 directly for storage. Aggregator 210 preferably aggregates the matching data and/or consensus data with other data relating to the corresponding transactions and stores the aggregate data in storage 212.

In a preferred operation of an embodiment of the present invention, routing system 204 receives new data and determines which node or cluster of nodes to which the data should be routed by indexing from or hashing one or more fields in the data. System 204 preferably generates a consistent hash from the contents of the selected data field. Preferably, the hashing operation is completed by a relayer within system 204. Based on the hash results, system 204 forwards the data to the corresponding node 208 or cluster of nodes in decentralized verification system 206.

To provide scalability, the node network engaged in the consensus protocol is preferable organized into independent sub-groups of nodes (called “clusters.”) Grouping of nodes so that incoming eventful data may be evenly distributed across different clusters (sets of nodes). Utilizing consistent hashing, events will be more evenly distributed among clusters of nodes. By adding more clusters to the network, more events per second may be supported.

In an alternate embodiment, to provide additional security, transaction data is sharded among sub-groups of nodes such that single sub-group of nodes will not process all data for any given dimension, parameter, transaction or the like, but rather will process a subset of data, to minimizes the impact of a sub-group of nodes being taken over by bad actors. By sharding data across clusters, it is more difficult for colluding nodes to affect the analytical results in significant ways, especially for high volume networks.

Optionally, a node 208 relays the data it receives to other nodes 208 in its cluster and the nodes 208 gossip about the incoming data with each other. Nodes 208 can have the capability to reach consensus outside of a smart contract by gossiping with other nodes (known as “off-chain consensus”) Conventional consensus mechanisms may be utilized such as proof-of-work, proof-of stake, Paxos, practical byzantine fault tolerance (PBFT) and the like. As a further alternative, each cluster of nodes 208 may come to a consensus using a byzantine fault tolerant smart contract on the blockchain. In a preferred embodiment, each cluster includes at least five (5) nodes 208, as it allows for there to be up to two (2) “bad” nodes in a given cluster while maintaining the integrity of the consensus mechanism.

After each cluster arrives at a consensus, the results of the analytics by that cluster may be stored in a database or other data structure, such as blockchain or the like. Alternatively, the data may also be hashed and the hash stored separate from the data. Preferably, the results are grouped by dimensions (e.g., campaign and channel ID), along with a set of metrics, (e.g., impressions, clicks, conversions).

Aggregator 210 combines the consensus results of all clusters for a related set of transactions utilizing a transcendent identifier (e.g., a campaign ID). The final results may be stored in storage 212 as a database or other data store, such as blockchain or the like. Alternatively, the final results may also be hashed and the hash stored in storage 212, along with or separate from the consensus results.

In an embodiment omitting aggregator 210, one or more of nodes 208 aggregates the matched and/or unmatched results and stores the results in storage 212.

In a further alternate embodiment, one or more of the transaction data, consensus results, aggregate data, and final results can be stored and queried in the nodes 208 themselves. That information can be verified by computing hashes and checking them against the pre-stored hashes in a blockchain.

In another alternate embodiment, decentralized verification system 206 is replaced with a processor implementing a zero-knowledge proof, e.g., a zero-knowledge succinct non-interactive argument of knowledge (zk-SNARK), a transparent zero-knowledge proof (zk-STARK), or the like. Transaction data from different sources are matched using a zero-knowledge proof to confirm that the match or lack of match was determined. The results can be stored directly in a blockchain in storage 212.

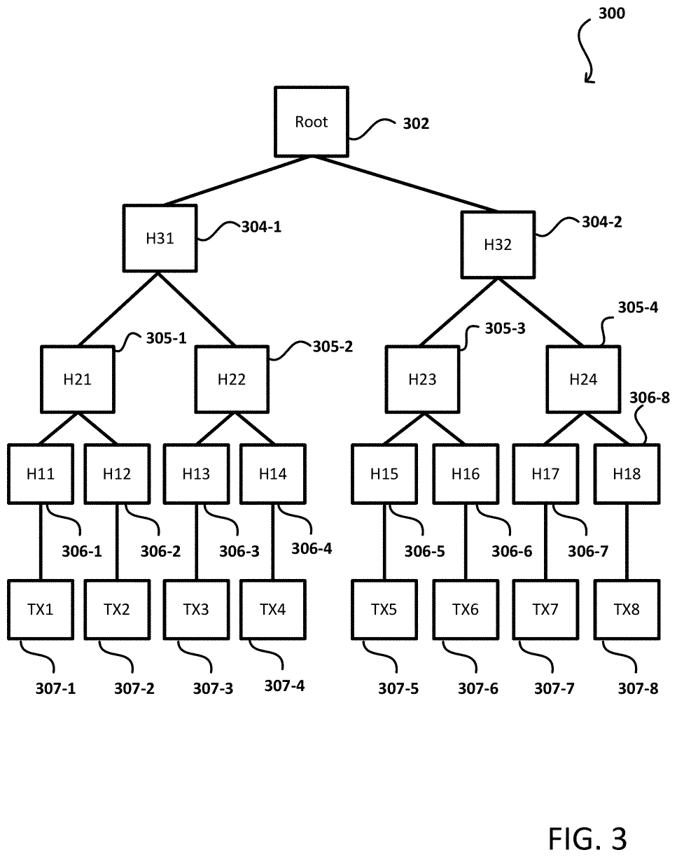

FIG. 3 is a diagram of an example Merkle tree data structure according to a preferred embodiment of the present invention. Hash 11 (H11) 306-1 is created by hashing transaction 1 (TX1) 307-1: H11=H(TX1). Hash 12 (H12) 306-2 is created by hashing transaction 2 (TX2) 307-2: H12=H(TX2). Hash 13 (H13) 306-3 is created by hashing transaction 3 (TX3) 307-3: H13=H(TX3). Hash 14 (H14) 306-4 is created by hashing transaction 4 (TX4) 307-4: H14=H(TX4). Hash 15 (H15) 306-5 is created by hashing transaction 5 (TX5) 307-5: H15=H(TX5). Hash 16 (H16) 306-6 is created by hashing transaction 6 (TX6) 307-6: H16=H(TX6). Hash 17 (H17) 306-7 is created by hashing transaction 7 (TX7) 307-7: H17=H(TX7). Hash 18 (H18) 306-8 is created by hashing transaction 8 (TX8) 307-8: H18=H(TX8).

Hash 21 (H21) 305-1 is created by hashing H11 and H12: H21=H(H11+H12). Hash 22 (H22) 305-2 is created by hashing H13 and H14: H22=H(H13+H14). Hash 23 (H23) 305-3 is created by hashing H15 and H16: H23=H(H15+H16). Hash 24 (H24) 305-4 is created by hashing H17 and H18: H21=H(H17+H18).

Hash 31 (H31) 304-1 is created by hashing H21 and H22: H21=H(H21+H22). Hash 32 (H32) 304-2 is created by hashing H23 and H24: H32=H(H23+H24). Finally, the Merkle root (root) 302 is created by hashing H31 and H32: root=H(H31+H32). One of ordinary skill in the art will appreciate that the resulting Merkle tree can be extended further levels down by further hashing operations.

A significant benefit of this Merkle tree structure is that allows quick verification that transaction data is accurate. For example, to prove that root 302 includes transaction 6 (TX6) 307-6, a Merkle proof is computed utilizing hash 15 (H15) 306-5, hash 24 (H24) 305-4, and hash (H31) 304-1. Preferably, the hashes are SHA 256 hashes, other conventional hashing algorithms, or the like for producing reduced size data fingerprints.

In a preferred embodiment, the root of the Merkle tree provides a fingerprint for validating the transactions within a campaign or within a consensus round among the verifiers in a campaign. A root value is computed by each verifier independently based on the data received from advertising campaign participants. The then-current state root is the root agreed upon by a majority of verifiers pursuant to the consensus mechanism implemented and is preferably stored in a public blockchain.

In one embodiment, each verifier receives event data from participants and may calculate additional event data and/or compute compound metrics. Then each verifier performs a time-series rollup of the campaign data and/or compound metrics. The metrics may include impressions (e.g., regular impressions, pixel impressions and the like), loaded impressions (e.g., DSP impressions), Decision Win Impressions (DSP impressions+impressions reported by an exchange), clicks on an advertisement, conversions, win cost, decision cost, time based measurements (e.g., video playback time pixels after specific lengths of the video have played such as each quartile of the video). Metric values may be computed in a map and/or reduced style set of functions. Grouped and rolled-up analytics can be viewed as data “segments,” somewhat similar to Apache Druid's time-series segments. Each segment preferably has a predictably computed identifier which is composed of its identifiers, values, and the campaign's smart contract address.

Data and/or metrics from a particular time period may be aggregated, added, or otherwise combined to form a data segment comprising fields of data for each of the relevant identifiers and metrics. The segment data may include aggregated counts on a per identifier basis and per metric basis. Identifiers may include, but are not limited to, advertiser identifier, advertisement identifier, campaign identifier, channel identifier, exchange identifier, app identifier, site identifier, agency identifier, publisher identifier, supplier identifier.

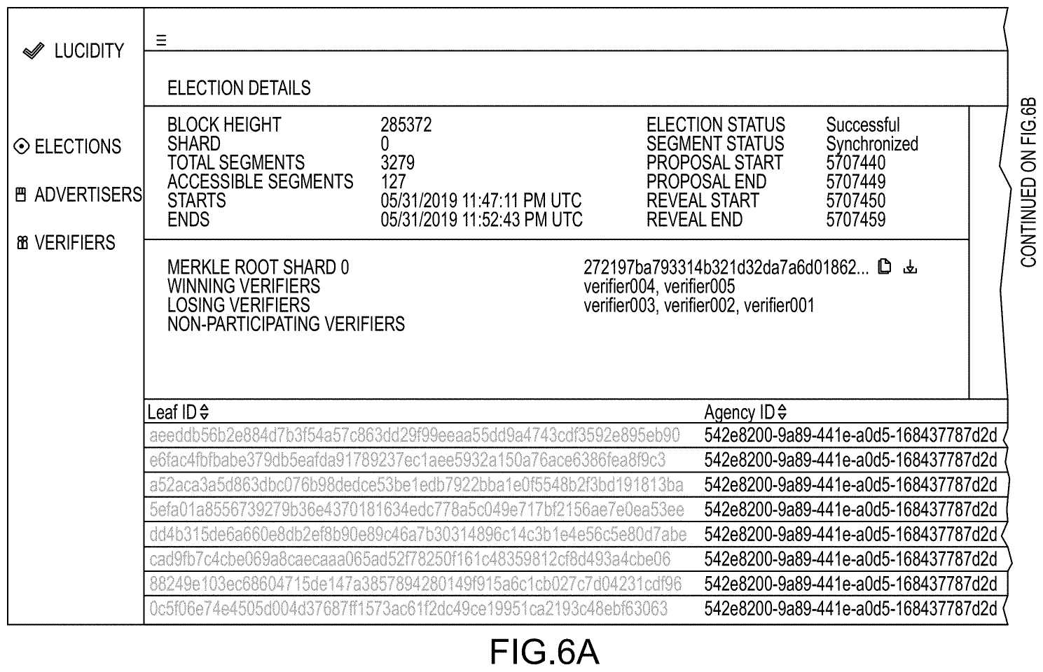

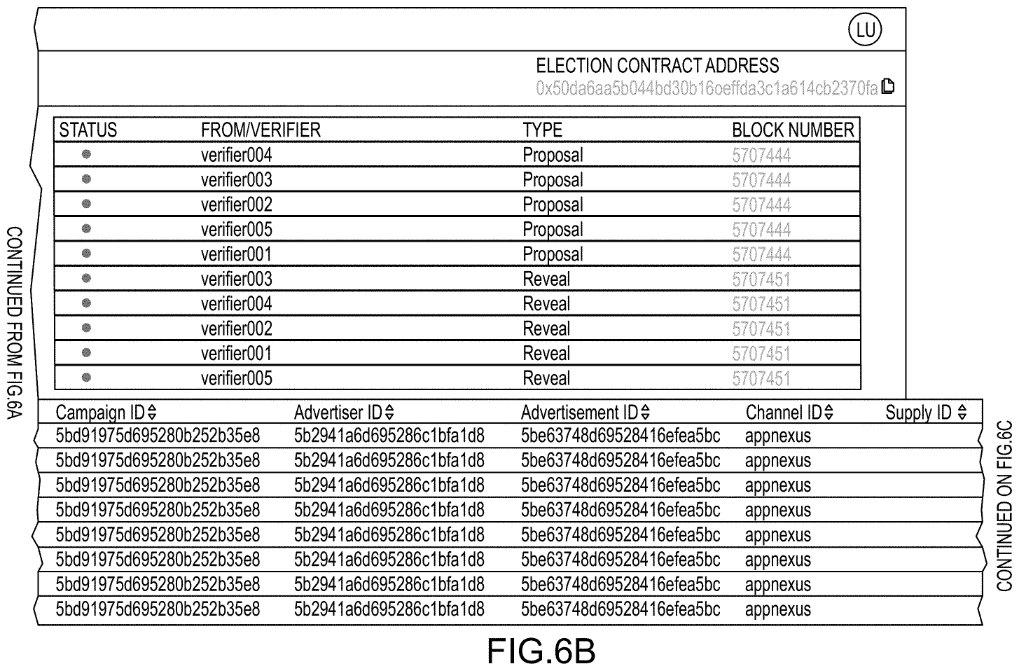

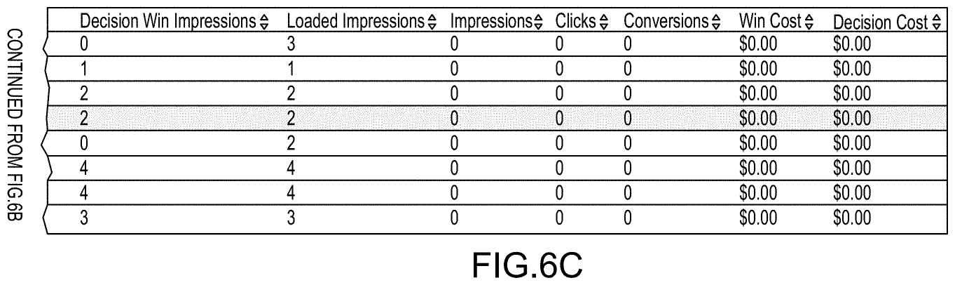

For example, each segment may include data for multiple identifiers and multiple metrics. See FIGS. 6A-6C discussed below. It should be understood that a segment may include more or less identifiers and metrics than shown.

A Merkle tree is then built by each verifier in which each leaf is a non-null value indexed by the segment's identifier. Preferably, each leaf of the Merkle tree is a hash of all of the data fields in a segment. Alternatively, each leaf of the Merkle tree is a hash of campaign data, campaign data metrics, compound metrics, a set of identifiers, a combination of the foregoing or the like. In a preferred embodiment, the leaf identifier is a hash of the segment data. The leaf identifiers and/or other portions of the Merkle tree can be used to create Merkle proofs according to conventional methods (see, for example, www.certificate-transparency.org/log-proofs-work).

Preferably, verifiers compute compound event data based on incoming event data. For example, from an impression event data and a win event data, a verifier may generate a “loaded impression” event data. During the verifier consensus process, the compound event data may be rolled up using time-series aggregation processes described above to create segments that are then hashed into a Merkle tree data structure. Alternatively the verifier may continuously or periodically perform the roll up of compound event data using time-series aggregation processes described above to create segments that are then hashed into a Merkle tree data structure.

Because the identifiers of the segments are predictably generated based on its content, a segment displayed to a participant can be proven to be valid by the participant viewing its specific set of analytics. The participant computes the expected segment identifier and checks it against that campaign's current state root preferably stored on a public blockchain by the verifiers. Alternatively, the entire Merkle tree is stored on a public blockchain for use by the participants to verify the content of segments.

A scalable high-frequency time-series database functionality is implemented with smart contracts. Sharding is used to break up the shared ledger into multiple sets and spread among neutral parties—which may be referred to as verifiers. Messages are eventful in nature and preferably composed of an event type and a set of identifiers. Smart contracts for the shared ledger provide rules for how to input time-series events and output other time-series events. As input events are received and output events are computed they are rolled up by a given set of identifiers to create segments.

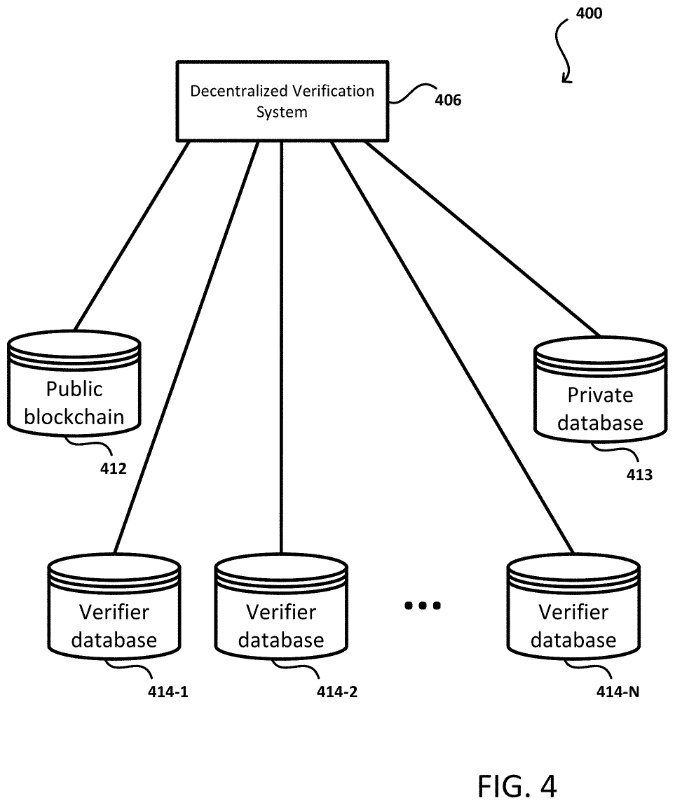

In FIG. 4, a distributed database system according to an embodiment of the present invention is shown. The decentralized verification system 406 is connected to a public blockchain 412, a private blockchain 413, and a set of verifier databases 414-1, 414-2, through 414-N. The verifiers in decentralized verification system 406 reach consensus to create segments containing, for example, campaign data, campaign metrics, or the like. Each segment is hashed and the hash is added to the Merkle tree data structure which is preferably stored, along with the segment, in both the verifier databases 414-1, 414-2, through 414-N and in private blockchain 413. The then-current root of the Merkle tree data structure is preferably stored in public blockchain 412.

In an alternate embodiment, a verifier receives individual event data, and based on logic within the verifier, output event data are generated. For example, a verifier may receive a win event data and an impression event data and generate a “loaded impression” event data. Output event data may be rolled up to create a set of segments, the segments are hashed, and the hashes can be put into a Merkle tree. Preferably as part of the consensus process, the verifiers perform a time-series roll-up on a set (or all) of the event data (e.g. impressions, wins, and loaded impressions) organized by identifier (e.g., advertiser id, campaign id, etc.). The rolled-up events are then called “segments” and include the set of data fields (e.g., identifiers) that were used for the roll-up and the metrics that were summed or otherwise aggregated as part of the roll-up process. For consensus, hashes of the time-series roll-ups (e.g., segments) are placed into a Merkle tree. Then the verifiers vote for consensus on the Merkle root of the Merkle tree. The final consensus Merkle root is preferably stored on the blockchain where the consensus was reached.

In order to provide privacy, the operators of the private blockchain 413 and the verifier databases 414-1, 414-2, through 414-N do not share the stored segments with other parties, except for a participant that owns the segment data. Participants can view the then-current root in the public blockchain 412 but does not have access to the segment data. Optionally, participants can view the entire Merkle tree storage structure in the public blockchain 412 or a subset thereof. Participants are given access to the segment data by the operators of the private blockchain 413 upon request. A participant may validate segment data with a Merkle proof based on the segment data received and the then-current root stored in the public blockchain 413. It is preferably if the only value which is publicly available to all participants are the Merkle roots stored in the public blockchain 413. In this way, privacy and security for all participant-specific data is provided.

By implementing time series merklization as described above, embodiments of the present invention provide confidentiality, security, and accuracy in a system of communications and recordkeeping involving multiple untrusting parties. Time-series aggregation is used to compress data in a blockchain ledger that receives a relatively high rate of data corresponding to high frequency events. Merkle trees storing hashes of the time-series aggregated data provide cryptographic proofs that can help ensure correctness of the computation of advertising metrics. Because only hashes of the time-series segments are stored within an accessible Merkle tree, users are able to validate advertising data they receive without having access to stored data that does not belong to the particular user.

In this way, it is possible to store millions of individual data segments off the public blockchain but keep proof of the authenticity of the stored individual segments on a public blockchain.

The public blockchain 412 may be operated by a consortium of entities or a centralized party. When operated by a consortium, each entity in the consortium may also operate as a verifier. Each verifier independently receives advertising event data and executes the smart contracts to create segments upon consensus. The consensus among the verifiers enables the creation of proofs that the smart contracts were executed correctly. The consensus can be achieved via a blockchain, traditional PBFT mechanisms, or any other means to achieve and store consensus.

When the shared ledger is operated by a centralized entity, the central party may store a Merkle tree's root in a publicly available place and provide users with the Merkle proofs to validate entries in the tree. This, however, may not enable proving correctness of computation. Optionally, zero knowledge proofs may be implemented to prove the correctness of computation of the aggregates.

Data stored in the Merkle tree structure is advantageously accessed, and its authenticity verified, utilizing an automated verification tool. A graphic user interface, preferably in the form of a dashboard display, allows a user to audit the data collected and computed during a campaign and access proof that the data was not subject to tampering.

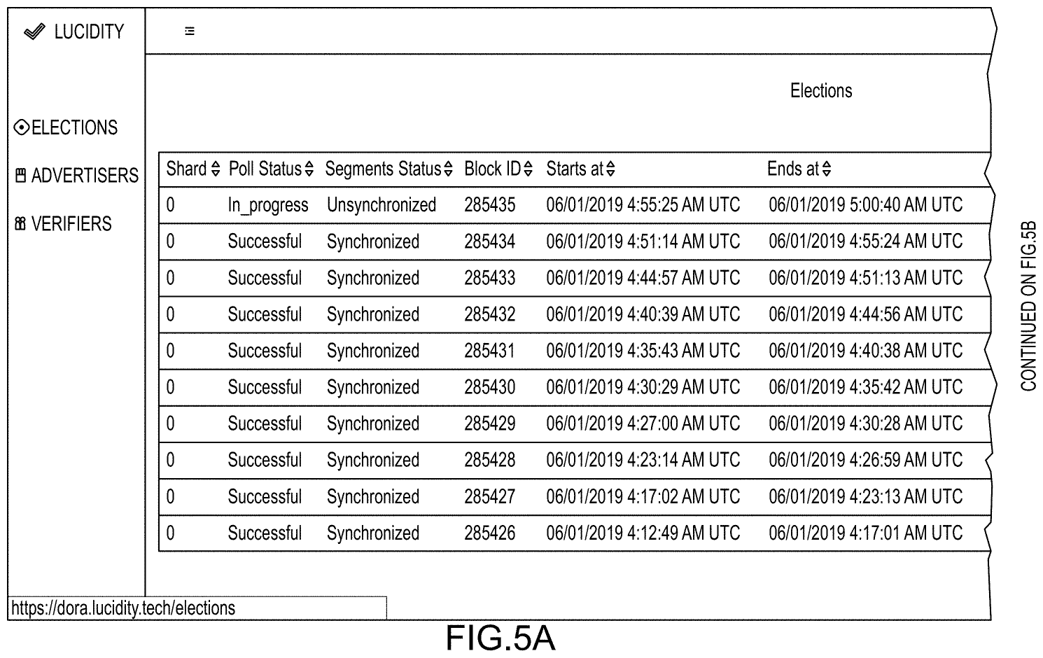

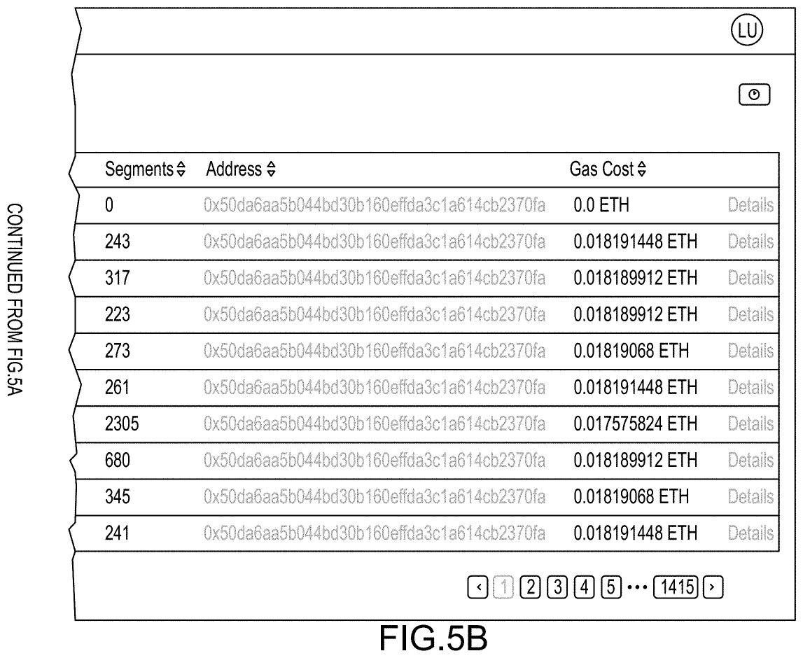

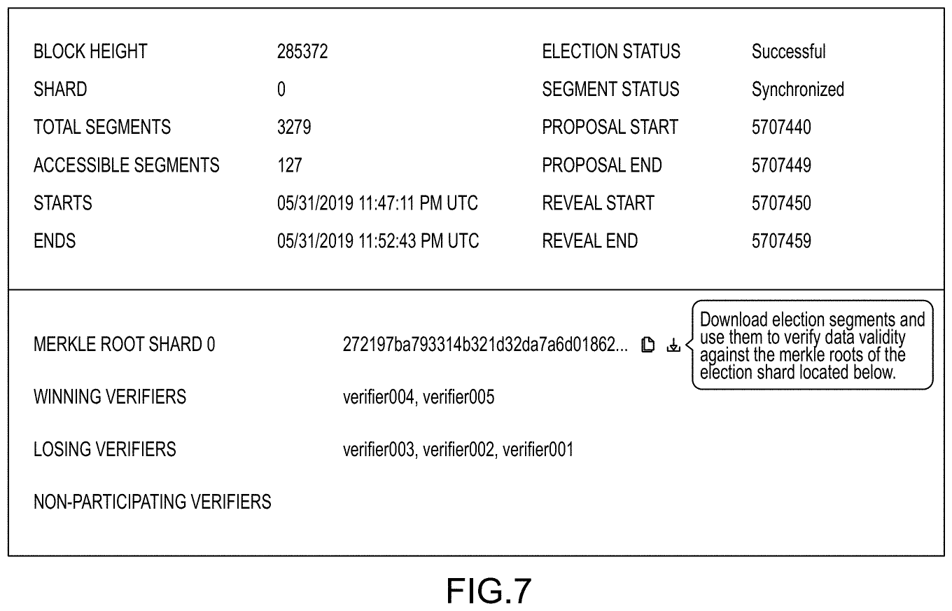

FIGS. 5A-5B, 6A-6C, and 7 are examples of dashboard graphic user interfaces for the verification tool according to a preferred embodiment of the present invention. In FIGS. 5A-5B, dashboard 500 shows campaign data on a per consensus round (called “election”) basis. When a user selects a particular election, a graphical user interface corresponding to dashboard 530 in FIG. 6 appears. Dashboard 530 shows an example of eight (8) segment containing Leaf ID, Agency ID, Campaign ID, Advertiser ID, Advertisement ID, Channel ID, Supply ID, Decision-Win Impressions, Loaded Impressions, Impressions, Clicks, Conversions, Win Cost, and Decision Cost. Upon selection of a particular segment in an election, a graphical user interface corresponding to dashboard 560 in FIG. 7 appears.

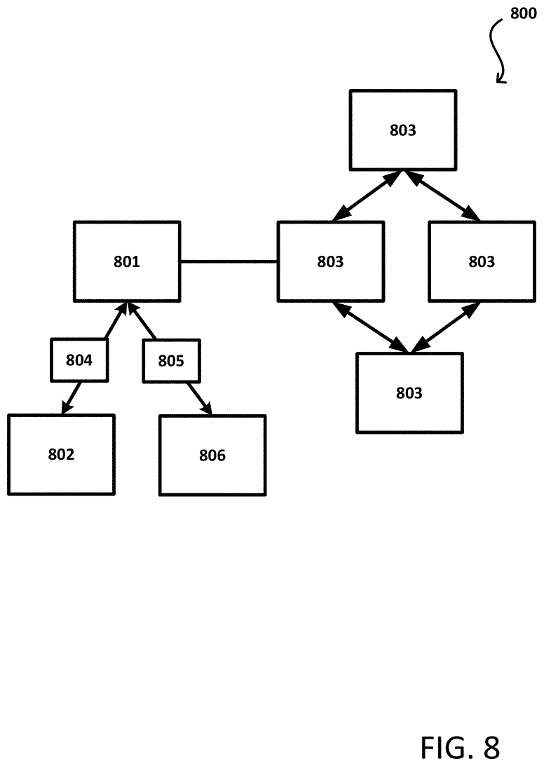

FIG. 8 is an exemplary illustration of participant 802 utilizing a smart contract 801 in the context of the present invention. First, a smart contract 801 may be deployed into a blockchain network 800 made up of nodes capable of performing verification 803 that monitor the smart contract for events such as the deposit and withdraw of cryptocurrency tokens. The blockchain network may be publicly accessible or private, and may include the Ethereum network or forks thereof. A participant 802 may then deposit an amount of cryptocurrency token 804, such as an ERC-20 token, into the smart contract 801 and specify payment terms for the smart contract 801. The cryptocurrency tokens deposited by the participant 804 may be stored at an address in the smart contract 801 corresponding to the participant. The smart contract 801 may also contain an address corresponding to a recipient 806. The nodes 803 each maintain a balance of the tokens present at each address in the smart contract 801. The payment terms may include specifying advertising metrics that must be achieved for payment or execution of the contract. Advertising metrics can be any measure of advertisement performance, such as impressions, clicks, conversions, and the like. The smart contract 801 may hold the deposit value as a balance on behalf of the participant, and send a withdraw value of tokens 805 to a recipient 806 when the payment terms of the smart contract 801 are satisfied. Nodes 803 of the blockchain network 800 may perform verification for the smart contract 801. For example, they may monitor the smart contract 801 for events, such as the satisfaction of payment terms and the deposit, withdraw, or other type of transfer of tokens 804, 805. Alternatively, the nodes 803 may be notified when deposits and withdrawal are made to the smart contract 801. When such events occur, the nodes 803 preferably update their balances to account for the deposit or withdrawal of tokens 804, 805.

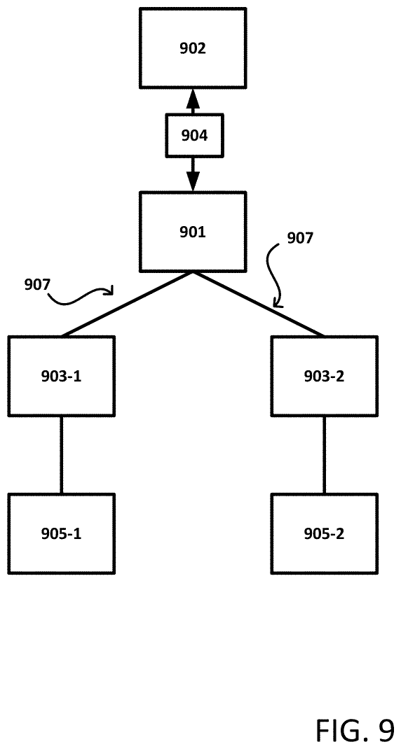

An exemplary embodiment is depicted in FIG. 9 wherein the nodes 903-1, 903-2 receive a notification 907 upon a deposit or withdrawal of a cryptocurrency token 904 from a participant 902 to a smart contract 901. The smart contract 901 may provide notifications to the nodes 903-1, 903-2 upon deposit or withdrawal of a cryptocurrency token 904. Alternatively, the nodes 903-1, 903-2 may monitor or query the smart contract 901 to obtain the balance of cryptocurrency tokens stored in the smart contract 901. The nodes 903-1, 903-2 may receive a new balance from the smart contract, or may be notified of the amount of deposit or withdrawal. Based on the notification, the nodes 903-1, 903-2 may update their balances representative of the balance of the smart contract 901.

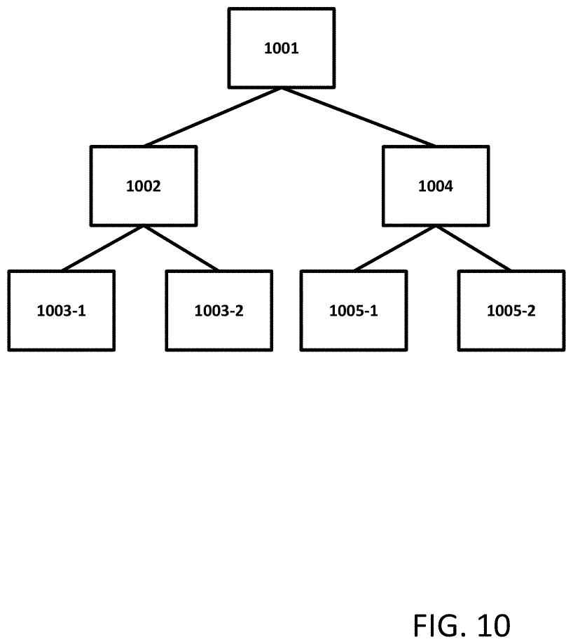

FIG. 10 depicts how balances may be managed by nodes in a Merkle tree 1000. The Merkle tree 1000 may contain a Merkle root 1001 and leaves 1002, 1003. The leaves 1002, 1003 contain information representing balances, such as balances of addresses corresponding to participants and recipients in smart contracts. The Merkle tree 1000 may be a sparse Merkle tree, wherein the leaves 1002, 1003 are indexed based on their position within the tree such that data placed in each leaf corresponds to a location tokens are stored, such as a cryptocurrency address. Data are arranged in the leaves 1002,1003 of the sparse Merkle tree such that participant balances stored on addresses corresponding to respective indexed leaves 1002, 1003 are consistent.

When a node determines that a metric—such as impressions, clicks, conversions, and the like—of an smart contract is fulfilled or satisfied, the node may update its balances of addresses corresponding to the parties to the smart contract, such as depositor participants and corresponding recipients. In performing this update, the node may deduct an amount specified in the smart contract from the depositor's address and add an amount specified in the smart contract to the recipient's address. Participants may be, among other things, purchasers of advertising, and recipients may be, among other things, publishers who run advertising. In performing these updates, the nodes may modify the balances contained in the leaves 1002, 1003 that are indexed to correspond to the participant's address and the recipient's address.

The Merkle tree structure representing balances 1000 may itself be part of a larger Merkle tree structure that includes additional Merkle tree structures, such as time-series Merkle trees structures, among others.

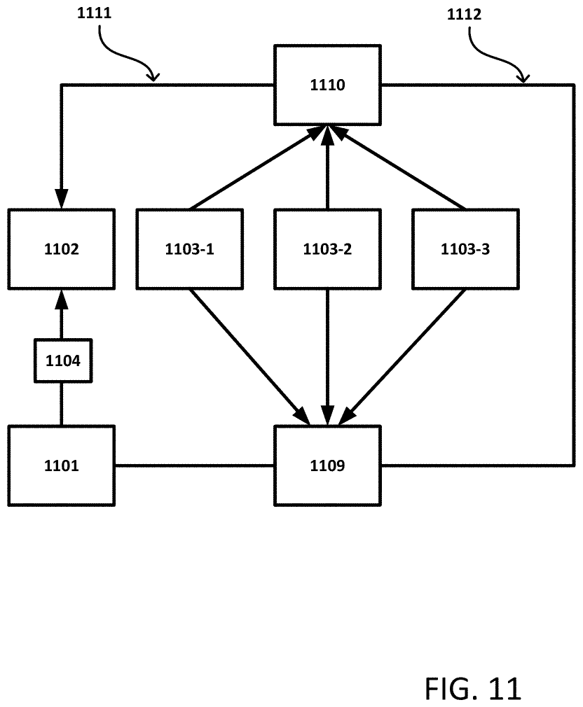

FIG. 11 depicts how the withdrawal of a token 1104 from a smart contract 1101 to a participant 1102 may be performed in accordance with an embodiment of the invention. A participant 1102 holding a balance of a cryptocurrency tokens in a smart contract 1101 may obtain a Merkle proof and the participant's balance 1111 from a block explorer 1110. A Merkle proof may be used to prove that certain data, such as a leaf (of a Merkle tree) containing a balance, belongs in a Merkle tree having a corresponding Merkle root. As described in relation to FIG. 10 above, a balance located in a Merkle tree may be indexed to correspond to a participant's address. A Merkle proof may be generated based on the data contained in a Merkle tree. Consensus may be reached on the network 1109 by the nodes 1103-1, 1103-2, 1103-3 coming to agreement on a Merkle root. The block explorer 1110 may receive a balance Merkle tree, which is preferably a sparse Merkle tree, from the nodes 1103-1, 1103-2, 1103-3 containing the balances of relevant addresses. And from the balance Merkle tree, the block explorer 1110 may calculate a Merkle root and verify 1112 that this calculated Merkle root is consistent with the Merkle root the network 1109 of nodes 1103-1, 1103-2, 1103-3 came to consensus on. The block explorer 1110 does not hold or own the balance amount, but may rather provide to the participant 1102 the participant's corresponding balance that the block explorer 1110 receives from nodes 1103-1, 1103-2, 1103-3 on a network 1109 for which the nodes have reached consensus. The smart contract 1101 may receive the Merkle root on which consensus was reached from the network 1109. The participant 1102 may request a withdrawal of tokens 1104 from its balance held on the smart contract 1101 by submitting to the smart contract 1101 the Merkle proof and the balance 1111 it obtained from the block explorer 1110. The participant 1102, in making the request for withdrawal may sign a transaction or otherwise prove ownership or control over private keys corresponding to a public key that corresponds to the address indexed to the participant's balance in the balance Merkle tree. The smart contract 1101 may compare the Merkle proof along with the balance 1111 received from the participant 1102 against the Merkle root the smart contract 1101 obtained from the network 1109. If the smart contract 1101 determines that the Merkle proof and balance 1111 correspond to the Merkle root, it may send tokens 1104 to the participant 1102, for example to an address corresponding to the participant.

The various implementations above are applicable in many different and varied operating environments, on one more electronic devices that incorporate integrated circuits, chips for processing and memory purposes. A system or method of the present disclosure also includes a number of the above exemplary systems working together to perform the same functions disclosed herein.

Example environments discussed herein for implementing aspects in accordance with various embodiments are primarily Web-based, as relate to Web services and cloud computing, but it should be appreciated that, although a Web-based environment is used for purposes of explanation, different environments may be used, as appropriate, to implement various embodiments. Client devices used to interact with various embodiments can include any appropriate device operable to send and receive requests, messages, or information over an appropriate network and convey information back to a user of the device. Examples of such client devices include personal computers, smart phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections, and combinations thereof using communication component, such as discussed throughout this disclosure.

It should be understood that there can be several application servers, layers, or other elements, processes, or components, which may be chained or otherwise configured, which can interact to perform tasks as discussed and suggested herein. As used herein the term “data store” refers to any device or combination of devices capable of storing, accessing, and retrieving data, which may include any combination and number of data servers, databases, data storage devices, and data storage media, in any standard, distributed, or clustered environment. The application server can include any appropriate hardware and software for integrating with the data store as needed to execute aspects of one or more applications for the client device, handling a majority of the data access and business logic for an application. The application server provides access control services in cooperation with the data store, and is able to generate content such as text, graphics, audio, and/or video to be transferred to the user, which may be served to the user by the Web server in the form of HTML, XML, or another appropriate structured language in this example. The handling of all requests and responses, as well as the delivery of content between a client device and a resource, can be handled by the Web server. It should be understood that the Web and application servers are not required and are merely example components, as structured code discussed herein can be executed on any appropriate device or host machine as discussed elsewhere herein.

A data store can include several separate data tables, databases, or other data storage mechanisms and media for storing data relating to a particular aspect. The data store is operable, through logic associated therewith, to receive instructions from a server, and obtain, update, or otherwise process data in response thereto. In one example, a user might submit a request for one or more symbols of one or more securities. In this case, the data store may respond with the information about current values or precomputed data portions. The current values or precomputed data portions may also come from an index database for faster access, and may include a timestamp indicating current date and time for the data. The information then can be returned to the buffer areas and may be deployed by respective executable code that processes the data first to provide a risk assessment with the data.

Each server will include an operating system that provides executable program instructions for the general administration and operation of that server, and will include a non-transitory computer-readable medium storing instructions that, when executed by a processor of the server, allow the server to perform its intended functions. Suitable implementations for the operating system and functionality of the servers are known or commercially available, and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are described. Thus, the depictions of various systems and services herein should be taken as being illustrative in nature, and not limiting to the scope of the disclosure.

Various aspects can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python®, or Tool Command Language (TCL), as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices will also include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and other non-transitory computer readable media for containing code, or portions of code, can include any appropriate media known or used in the art, including storage media and communication media, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A decentralized analytics system comprising:
a plurality of data sources;
a decentralized verification system;
a routing system, connected to said plurality of data sources and said decentralized verification system, for routing transaction data from said plurality of data sources to said decentralized verification system;
wherein said decentralized verification system compares the transaction data to identify matched transaction data and unmatched transaction data;
a private storage, connected to said decentralized verification system, to store the matched transaction data; and
a public storage, connected to said decentralized verification system, to store a hash of the matched transaction data.

2. The decentralized analytics system of claim 1, wherein said decentralized verification system comprises a plurality of computer processing nodes.

3. The decentralized analytics system of claim 2, wherein said plurality of computer processing nodes verifies the matched transaction data via a consensus protocol.

4. The decentralized analytics system of claim 2, wherein said plurality of data sources includes an advertiser and a publisher.

5. The decentralized analytics system of claim 4, wherein said plurality of data sources includes a demand side platform and a supply side platform.

6. The decentralized analytics system of claim 1, further comprising a user dashboard configured to display the matched transaction data and the hash of the matched transaction data.

7. The decentralized analytics system of claim 1, wherein the matched transaction data is combined with third-party data and the hash comprises a hash of the matched transaction data and third-party data.

8. The decentralized analytics system of claim 1, wherein the public storage is a public blockchain.

9. A decentralized analytics processing method comprising the steps of:
routing transaction data from a plurality of data sources to a decentralized verification system;
comparing transaction data with a decentralized plurality of processing resources to identify at least one of matched transaction data and unmatched transaction data;
time-series aggregating matched transaction data to produce aggregate data;
storing aggregate data in a private storage; and
storing a hash of the aggregate data in a public storage.

10. The decentralized analytics processing method of claim 9, further comprising the step of verifying the matched transaction data via a consensus protocol.

11. The decentralized analytics processing method of claim 9, wherein the step of storing a hash comprises storing the hash in a Merkle tree structure stored in said private storage and storing the Merkle root in said public storage.

12. The decentralized analytics processing method of claim 9, wherein the transaction data includes at least one of a session identifier, a campaign identifier, and an advertising impression.

13. An analytics processing method comprising the steps of:
routing transaction data from a plurality of data sources to a verification system;
comparing transaction data to identify at least one of matched transaction data and unmatched transaction data utilizing a zero-knowledge proof;
storing at least one of the matched transaction data in a private storage; and
storing a hash of at least one of the matched transaction data in a public storage.

14. The decentralized analytics processing method of claim 13, wherein the step of storing a hash comprises storing the hash in a Merkle tree structure stored in said private storage and storing the Merkle root in said public storage.
